(19) United States
(12) Patent Application Publication
(10) Pub. No.: US 2007/0218791 A1
(43) Pub. Date: Sep. 20, 2007

(54) Artificial leather with even imprinted texture and method for making the same

(75) Inventors: Mao-Kan Lee, Liujiao Shiang (TW); Zhing-Hung Chen, Qianzhen (TW); Ming-Chang Cheng, Sanmin (TW); Yung-Hsiang Chou, Pingtung County (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SAN FANG CHEMICAL INDUSTRY CO., LTD., Jenwu Shiang (TW)

(21) Appl. No.: 11/494,370

(22) Filed: Jul. 27, 2006

(30) Foreign Application Priority Data
Mar. 15, 2006 (TW) 095108863

(51) Int. Cl. B32B 5/02

(52) U.S. Cl. 442/59; 442/102; 442/97; 442/100; 442/172

(57) ABSTRACT

There is disclosed artificial leather with even imprinted texture and a method for making the same. The method includes the steps of: making a thermally imprintable polyurethane resin foil into a first substrate; providing at least one polyurethane resin layer on the first substrate in a spotted manner or by rolling or spraying; making pre-determined texture or graphics on the polyurethane resin layer by imprinting; making non-woven fabric, elastic fabric, woven fabric or ultra-fine fiber materials into a second substrate; and providing the first substrate on the second substrate by adhesion so as to form the artificial leather with even imprinted texture.

### BACKGROUND OF INVENTION

1. Field of the Invention

The present invention relates to artificial leather with even imprinted texture and a method for making the same and, more particularly, to a method for providing excellent evenness of texture of artificial leather and a resultant product.

2. Related Prior Art

At present, artificial leather used in sports gear (such as balls and sneakers), leather decoration (clothing, decoration, shoes and purses), furnishings (such as sofas, tablecloths and pads) and the like appeals to texture like that of real leather.

Conventionally, to make artificial leather with texture like that of real leather, a substrate made of non-woven fabric or woven fabric is generally submerged in a polyurethane resin composition so as to form a submergence layer in the substrate. After curing, the substrate is coated with the polyurethane resin composition. After curing, washing and drying, an open porous polyurethane resin layer is formed in the substrate so that a semi-product of the artificial leather is made. Then, the substrate is coated with a polyurethane resin layer. Then, imprinting is conducted so as to form pre-determined imprinted texture on the surface of the substrate. Then, furnishing is conducted so as to form a final product of the artificial leather with imprinted texture.

The artificial leather made in the foregoing method exhibits a nice feel and proper hardness. However, the evenness of the imprinted texture is not satisfactory so that the quality of material and touch feeling of the texture imitative of that of real leather are not as good as expected. The reason is that after the substrate semi-product goes through the wet finished including submerging, curing, washing and drying, it is difficult to control the evenness of the thickness thereof. Therefore, for some of the products of the sports gear, leather decoration, furnishing or the like that are particular about the quality of material of the texture, there is a need for artificial leather with even imprinted texture.

The present invention is therefore intended to obviate or at least alleviate the problems encountered in prior art.

### SUMMARY OF INVENTION

It is an objective of the present invention to provide artificial leather with even imprinted texture so as to improve the evenness of the texture after imprinting the final product of the artificial leather or at least to provide the masses with a beneficial choice in the leather materials of the products of the sneakers, leather decoration or furnishing.

It is another objective of the present invention to provide a method for making artificial leather with even imprinted texture so as to make artificial leather with excellent evenness of texture thereof without having to make different semi-products for different requirements of products.

According to the present invention, a method includes the steps of: making a polyurethane resin foil into a first substrate with a front surface and a rear surface; providing at least one polyurethane resin layer on the first substrate; imprinting the polyurethane resin layer; and providing a second substrate beneath the rear surface of the first substrate.

The first substrate is preferably made of a thermally imprintable polyurethane resin foil with thickness of 0.1 to 2.0 mm and, more preferably, 0.3 to 0.8 mm.

The polyurethane resin layer is provided on the front surface of the first substrate in a spotted manner or by rolling or spraying.

In an embodiment, the polyurethane resin layer that forms a superficial layer is coated on releasing paper and than transferred to the front surface of the first substrate.

The front surface of the first substrate is imprinted by driving a roller with texture or graphics on the polyurethane resin layer so that the texture reaches the first substrate.

The second substrate is made of non-woven fabric, elastic fabric, woven fabric and/or ultra fine fiber (finer than 0.55 dtex).

The first substrate is provided on the second substrate by adhesion such as in a spotted manner or by rolling or spraying. In an embodiment, the thermal imprintable polyurethane resin foil that forms the first substrate is coated on releasing paper and than transferred to the second substrate. After the first and second substrates are bonded, they are preferably positioned in a curing chamber for about 24 to 48 hours so as to form the final product of the composite artificial leather with even imprinted texture.

In an embodiment, there is a bonding layer between the first substrate and the releasing paper for bonding the first substrate to the second substrate. The bonding layer is made of polyurethane resin coated on the releasing paper.

In another embodiment, a bonding layer is directly coated on the second substrate for bonding the first substrate to the second substrate. The bonding layer mainly consists of polyurethane resin.

The artificial leather according to the present invention includes a first substrate made of a polyurethane resin foil, a polyurethane resin layer coated on a front surface of the first substrate and imprinted with texture and a second substrate bonded to a rear surface of the first substrate. The texture is made before the bonding of the first and second substrates, and includes excellent evenness.

Other objectives, advantages and features of the present invention will become apparent from the following description referring to the attached drawings.

### BRIEF DESCRIPTION OF DRAWINGS

The present invention will be described through detailed illustration of the preferred embodiment referring to the drawings.

FIG. 1 is a cross-sectional view of a semi-product of artificial leather according to the preferred embodiment of the present invention.

FIG. 2 is a cross-sectional view of a second substrate bonded to the semi-product of the artificial leather shown in FIG. 1.

FIG. 3 is a cross-sectional view of two second substrates bonded to the semi-product of the artificial leather shown in FIG. 1.

### DETAILED DESCRIPTION OF PREFERRED EMBODIMENT

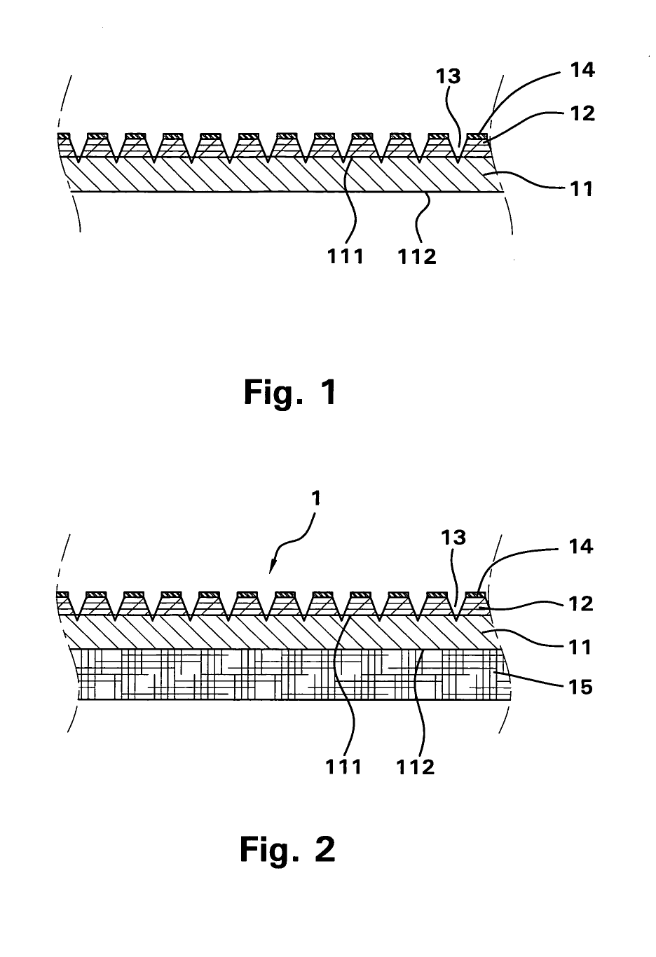

FIG. 1 is a cross-sectional view of a semi-product of artificial leather 1 according to the preferred embodiment of the present invention. The semi-product includes a first substrate 11 with a front surface 111 and a rear face 112, at least one superficial layer 12 coated on the front surface 111 of the first substrate 11, texture 13 formed on the superficial layer 12 and at least one finished layer 14 coated on the texture 13. It should be noted that the cross-sectional view is drawn for the purpose of illustration but not drawn in proportion.

The first substrate 11 is preferably a thermally imprintable polyurethane resin foil or made of any other proper elastomer. The 10 thickness of the first substrate is 0.1 to 2.0 mm and, more preferably, 0.3 to 0.8 mm.

The superficial layer 12 coated on the first substrate 11 is preferably a polyurethane resin layer, or any other proper elastomer imprinted with texture may be made into the superficial layer 12.

While coating the superficial layer 12 on the first substrate 11, in a spotted manner or by rolling or spraying, at a quantity of 20 to 300 g/m² and, more preferably, 20 to 160 g/m², one or more layers of polyurethane resin are coated on the front surface 111 of the first substrate 11. In an embodiment, the polyurethane resin layer that forms the superficial layer is coated on releasing paper and then transferred to the front surface 111 of the first substrate 11. After the polyurethane resin layers are cured, a semi-product is made with excellent evenness without the drawback of uneven thickness of a conventional semi-product. This is the key to the excellent evenness of the texture.

While imprinting the superficial layer 12 coated on the first substrate 11, after the drying of the superficial layer 12, a roller with texture or graphics is driven on the polyurethane resin layer 12 so that the texture reaches the first substrate 11 so that a semi-product with imprinted texture is formed. To imprint is to transfer texture or graphics on a roller that can or cannot be heated to the superficial layer 12. The temperature for imprinting is 40 to 280 Celsius degrees and, more preferably, 140 to 210 Celsius degrees.

Based on needs, chemical composition is coated at a quantity of 20 to 300 g/m and, more preferably, 20 to 160 g/m². It is understood that the foil imprinted semi-product is further finished so as to change the color, touch-difficult-feeling and lighting of the texture of the polyurethane resin foil. After this surface is finished so as to form the finished layer 14, there is formed a foil imprinted semi-product ready for bonding to the second substrate.

The chemical composition includes one or more of polyamide, polyurethane, silicone-containing chemical composition and wax-containing chemical composition.

Referring to FIG. 2 where the rear surface 112 of the first substrate 11 shown in FIG. 1 is provided on the second substrate 15. The second substrate 15 is provided on the first substrate 11 in a spotted manner or by rolling or spraying. Thus, a bonding layer (not shown) is formed as a bonding interface. The quantity of the bonding layer is 20 to 300 g/m² and, more preferably, 20 to 160 g/m². What is known about such a coating technique is as follows:

Polyurethane is coated on releasing paper so as to form a bonding layer. Then, the bonding layer is provided on the first substrate. After the releasing paper is removed, it can adhere to the second substrate.

Alternatively, polyurethane is coated on the second substrate so as to form a bonding layer for the adhering of the first substrate.

Based on different products, the second substrate 15 is non-woven fabric, elastic fabric, split leather, woven fabric and/or ultra fine fiber. Its thickness is preferably 0.5 to 2.0 mm.

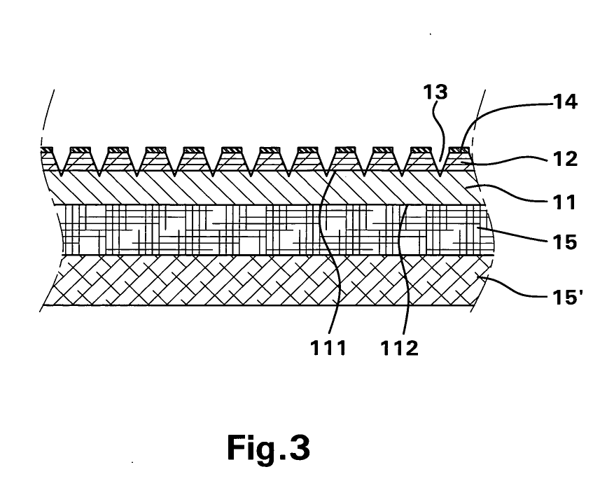

For example, an ultra fine fiber semi-product is used as the second substrate 15 and is bonded to the semi-product with imprinted texture shown in FIG. 1. After curing, an ultra fiber final product is made. Alternatively, elastic fabric is used as the second substrate 15 and bonded to the semi-product with imprinted texture shown in FIG. 1. After curing, an elastic fabric final product is made. Alternatively, non-woven fabric is used as the second substrate 15 and bonded to the semi-product with imprinted texture shown in FIG. 1. After curing, a non-woven fabric final product is made. Alternatively, woven fabric is used as the second substrate 15 and bonded to the semi-product with imprinted texture shown in FIG. 1. After curing, a woven fabric final product is made. Alternatively, referring to FIG. 3, the final product shown in FIG. 1 can be bonded to another second substrate semi-product 15′ (an ultra fine fiber semi-product for example). Thus, a composite final product is made.

The following examples are given to describe the present invention in further detail.

### EXAMPLE 1

A polyurethane resin foil with thickness of 0.3 mm is used as a substrate. Polyurethane resin is coated on the polyurethane resin foil in a spotted manner or rolling or spraying (quantity: 50 g/m²). After drying, by roller thermal imprinting (temperature: 150 Celsius degrees), the texture or graphics of the roller are imprinted on the front surface of the polyurethane foil. Then, by coating of chemical composition (quantity: 20 g/m²), the color, touch-difficult-feeling and lighting of the texture of the polyurethane resin foil is changed. Then, in a spotted manner or by rolling or spraying (quantity: 80 g/m²), it is attached to an ultra fine fiber semi-product with thickness of 1.0 mm. Thus, an ultra fine fiber product with excellent evenness of texture of imprinted texture is made.

### EXAMPLE 2

A polyurethane resin foil with thickness of 0.4 mm is used as a substrate. Polyurethane resin is coated on the polyurethane resin foil in a spotted manner or rolling or spraying (quantity: 50 g/m²). After drying, by roller thermal imprinting (temperature: 160 Celsius degrees), the texture or graphics of the roller are imprinted on the front surface of the polyurethane foil. Then, by coating of chemical composition (quantity: 20 g/m²), the color, touch-difficult-feeling and lighting of the texture of the polyurethane resin foil is changed. Then, in a spotted manner or by rolling or spraying (quantity: 80 g/m²), it is attached to non-woven fabric with thickness of 0.9 mm. Thus, a non-woven fabric product with excellent evenness of texture of imprinted texture is made.

### EXAMPLE 3

A polyurethane resin foil with thickness of 0.6 mm is used as a substrate. Polyurethane resin is coated on the polyurethane resin foil in a spotted manner or rolling or spraying (quantity: 50 g/m²). After drying, by roller thermal imprinting (temperature: 200 Celsius degrees), the texture or graphics of the roller are imprinted on the front surface of the polyurethane foil. Then, by coating of chemical composition (quantity: 20 g/m²), the color, touch-difficult-feeling and lighting of the texture of the polyurethane resin foil is changed. Then, in a spotted manner or by rolling or spraying (quantity: 80 g/m²), it is attached to woven fabric with thickness of 0.6 mm. Thus, a woven fabric product with excellent evenness of texture of imprinted texture is made.

### EXAMPLE 4

A polyurethane resin foil with thickness of 0.6 mm is used as a substrate. Polyurethane resin is coated on the polyurethane resin foil in a spotted manner or rolling or spraying (quantity: 50 g/m²). After drying, by a heavy or light roller, the texture or graphics of the roller are imprinted on the front surface of the polyurethane foil. Then, by coating of chemical composition (quantity: 20 g/m²), the color, touch-difficult-feeling and lighting of the texture of the polyurethane resin foil is changed. Then, it is attached to an ultra fiber semi-product with thickness of 1.1 mm. Thus, an ultra fine fiber product with excellent evenness of texture of imprinted texture is made.

### EXAMPLE 5

A polyurethane resin foil with thickness of 0.8 mm is used as a substrate. Polyurethane resin is coated on the polyurethane resin foil in a spotted manner or rolling or spraying (quantity: 50 g/m²). After drying, by roller thermal imprinting (temperature: 200 Celsius degrees), the texture or graphics of the roller are imprinted on the front surface of the polyurethane foil. Then, by coating of chemical composition (quantity: 20 g/m²), the color, touch-difficult-feeling and lighting of the texture of the polyurethane resin foil is changed. Then, in a spotted manner or by rolling or spraying (quantity: 80 g/m²), it is attached to woven fabric or non-woven fabric with thickness of 0.7 mm. Then, in a spotted manner or by rolling or spraying (quantity: 80 g/m²), an ultra fine fiber semi-product with thickness of 0.9 mm is bonded. Thus, a composite product with excellent evenness of texture of imprinted texture is made.

### EXAMPLE 6

A polyurethane resin foil with thickness of 0.8 mm is used as a substrate. Polyurethane resin is coated on the polyurethane resin foil in a spotted manner or rolling or spraying (quantity: 50 g/m²). After drying, by a heavy or light roller, the texture or graphics of the roller are imprinted on the front surface of the polyurethane foil. Then, by coating of chemical composition (quantity: 20 g/m²), the color, touch-difficult-feeling and lighting of the texture of the polyurethane resin foil is changed. Then, in a spotted manner or by rolling or spraying (quantity: 80 g/m²), it is attached to woven fabric or non-woven fabric with thickness of 0.7 mm. Then, in a spotted manner or by rolling or spraying (quantity: 80 g/m²), an ultra fine fiber semi-product with thickness of 0.5 mm is bonded. Thus, a composite product with excellent evenness of texture of imprinted texture is made.

The appeals of the present invention are the use of the polyurethane resin foil as the substrate of the imprinted texture and the use of at least one polyurethane resin layer as the imprinted layer. Because at least one imprinted layer is added to the first substrate, the imprinted layer includes better superficial smoothness, and the superficial smoothness will not be affected because of contraction during the drying. Therefore, compared with conventional substrates with uneven thickness, the thickness of the imprinted layer of the present invention is consistent. Moreover, since the thickness is perfectly even after the imprinting, the layer with perfect evenness of the thickness can be bonded to the second substrate semi-product to make the leather product with extraordinarily even imprinted texture. The leather product can be provided on the surface of sports material, leather decoration, furnishing or electronics, and increase the quality of material and added values of the products to achieve the expected purposes of design and effects of use.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A method for making artificial leather with even imprinted texture, the method comprising the steps of:
making a polyurethane resin foil into a first substrate with a front surface and a rear surface;
coating the front surface of the first substrate with at least one polyurethane resin layer so as to form a superficial layer;
imprinting the front surface of the polyurethane resin layer with texture; and
providing a second substrate beneath the rear surface of the first substrate so as to form the artificial leather with even imprinted texture.

2. The method according to claim 1 wherein the first substrate is preferably made of a thermally imprintable polyurethane resin foil.

3. The method according to claim 1 wherein the thickness of the first substrate is of 0.1 to 2.0 mm.

4. The method according to claim 1 wherein the polyurethane resin layer is provided on the front surface of the first substrate in a spotted manner or by rolling or spraying at a quantity of 20 to 300 g/m².

5. The method according to claim 1 wherein the step of imprinting is conducted at 40 to 280 Celsius degrees.

6. The method according to claim 1 comprising the step of finishing the imprinted front surface so as to change the color, touch-difficult-feeling and lighting of the texture of the polyurethane resin foil after the step of imprinting.

7. The method according to claim 6 wherein the step of finishing is done with at least one of polyamide, polyurethane, silicone-containing chemical composition and wax-containing chemical composition at a quantity of 40 to 300 g/m².

8. The method according to claim 1 wherein the second substrate is bonded to the rear surface of the first substrate in a spotted manner or by rolling or spraying at a quantity of 20 to 300 g/m².

9. The method according to claim 1 wherein the second substrate is selected from non-woven fabric, elastic fabric, woven fabric, split leather and ultra fine fiber.

10. The method according to claim 1 wherein the front surface of the first substrate is imprinted by a roller formed with texture and graphics.

11. Artificial leather with even imprinted texture, the artificial leather comprising:
a first substrate made of a polyurethane resin foil and with a front surface and a rear surface;
at least one superficial layer coated on a first substrate and made with imprinted texture; and
a second substrate bonded to the rear surface of the first substrate.

12. The artificial leather according to claim 11 wherein the imprinted texture reaches the first substrate.

13. The artificial leather according to claim 11 wherein the thickness of the first substrate is 0.1 to 2.0 mm.

14. The artificial leather according to claim 11 wherein the superficial layer is a polyurethane layer.

15. The artificial leather according to claim 11 wherein the first substrate is a thermally imprintable polyurethane foil.

16. The artificial leather according to claim 11 comprising a finished layer on the front surface of the first substrate so as to change the color, touch-difficult-feeling and lighting of the texture of the imprinted texture.

17. The artificial leather according to claim 16 wherein the finished layer comprises composition selected from polyamide, polyester, silicone-containing chemical composition and wax-containing chemical composition.

18. The artificial leather according to claim 11 wherein the second substrate is selected from non-woven fabric, elastic fabric, split leather, woven fabric and ultra fine fiber.

19. The method according to claim 2 wherein the thickness of the first substrate is of 0.1 to 2.0 mm.
